(19) United States
(12) Patent Application Publication
(10) Pub. No.: US 2019/0178528 A1
(43) Pub. Date: Jun. 13, 2019

(54) WATER HEATER SYSTEM

(71) Applicant: A.O. SMITH (CHINA) WATER HEATER CO., LTD., Nanjing (CN)

(72) Inventors: Huaxin WAN, Nanjing (CN); Zhenhu YAO, Nanjing (CN); Hua WANG, Nanjing (CN); Kuiwen WANG, Nanjing (CN)

(21) Appl. No.: 16/279,801

(22) Filed: Feb. 19, 2019

Related U.S. Application Data
(63) Continuation of application No. PCT/CN2017/092899, filed on Jul. 14, 2017.

(30) Foreign Application Priority Data
Jul. 14, 2016 (CN) 201610557169.6

(51) Int. Cl. F24H 1/18; B01F 3/04; B01F 5/04; B01F 5/12

(52) U.S. Cl. CPC F24H 1/18; B01F 3/04099; B01F 2215/008; B01F 5/12; B01F 2003/04858; B01F 5/0415

(57) ABSTRACT

The present invention discloses a water heater system, comprising: a heating unit capable of heating water; a pump communicated with the heating unit; a gas inlet structure disposed on or communicated with the pump, the pump being capable of mixing a gas and water flowing into it; and a pressure regulating device disposed downstream of the pump. The water heater system provided in the present invention is applicable to scenarios of any existing water heaters, including electric water heaters, gas water heaters, solar water heaters, air-source water heaters, etc., and can produce micro-bubble water for use by the users, which is not only water saving but also environmental protective. Moreover, the micro-bubble water has a strong cleaning performance, and thereby greatly improves the user experiences.

### CROSS REFERENCE TO RELATED APPLICATIONS

The present application claims the priority of the Chinese patent application No. 201610557169.6 entitled “Water Heater System” filed on Jul. 14, 2016, of which the entire content is incorporated by reference in the present application.

### TECHNICAL FIELD

The present application relates to the field of water heaters, in particular relates to a water heater system.

### BACKGROUND

At present, domestic water heater products mainly include electric water heaters, gas water heaters, solar water heaters and air-source water heaters, etc. The field of water heaters is dominated by traditional electric water heaters and gas water heaters.

As people's living standard improves increasingly, they have higher and higher requirements for water heaters. For example, in addition to the basic requirements of safety and reliability, the users also have further requirements for water heaters, such as water conservation, environmental protection, comfort and health.

Therefore, there is a necessity to improve the current water heaters so as to better meet the user requirements and improve the user experiences.

### SUMMARY

The object of the present invention is to provide a water heater system that can produce micro-bubble water for use by the users, which is not only water saving and environmental protective, but also has a strong cleaning performance, and thus the user experiences would be improved greatly.

The above object of the present invention can be realized by adopting the following technical solutions.

A water heater system, comprising: a heating unit capable of heating water; a pump communicated with the heating unit; a gas inlet structure disposed on or communicated with the pump; the pump being capable of mixing the gas and water flowing into it.

Further, the water heater system further comprises a pressure regulating device which is disposed downstream of the pump.

Further, the pump is a gas-liquid mixing pump, the gas inlet structure is a gas inlet portion disposed on the gas-liquid mixing pump, and the gas flows from the gas inlet portion into the gas-liquid mixing pump to be mixed with the water.

Further, the pump is a gas-liquid mixing pump, and the gas inlet structure is disposed on a water supply pipe which is upstream of the gas-liquid mixing pump.

Further, the gas inlet structure is provided with a Venturi structure.

Further, the pump is disposed upstream of the heating unit, and the pressure regulating device is disposed downstream of the heating unit.

Further, the pump and the pressure regulating device are disposed downstream of the heating unit.

Further, the pump and the pressure regulating device are disposed upstream of the heating unit.

Further, the heating unit comprises: a liner capable of containing water and a heating member used for heating the water in the liner.

Further, the water heater system further comprises a pressure regulating device which is disposed downstream of the pump.

Further, the liner is provided with a water inlet pipe for inputting water and a water outlet pipe for outputting water, the pump is disposed upstream of the water inlet pipe, and the pressure regulating device is disposed downstream of the water outlet pipe.

Further, the liner is provided with a water inlet pipe for inputting water and a water outlet pipe for outputting water, and the pump and the pressure regulating device are disposed downstream of the water outlet pipe.

Further, the liner is provided with a water inlet pipe for inputting water and a water outlet pipe for outputting water, and the pump and the pressure regulating device are disposed upstream of the water inlet pipe.

Further, the liner is a pressure-bearing liner which has a liner pressure ranged from 0.1 MPa to 0.8 MPa.

Further, the water heater system further comprises a tank which is capable of being communicated with the pump for further mixing the gas and water, the tank is disposed downstream of the pump, and the pressure regulating device is disposed downstream of the tank.

Further, the gas inlet structure is a tank which is capable of gas supply and used for supplying gas to the water flowing through it.

Further, the pump comprises a first pump and a second pump which are connected with each other in series or in parallel.

Further, when the pump is started to be operated, the pressure regulating device can maintain a pressure between the pump and the pressure regulating device above 0.2 Mpa.

Further, the heating unit comprises: a heat exchanger through which water can flow, and a heating means for heating the water that flows through the heat exchanger.

Further, the water heater system further comprises a pressure regulating device which is disposed downstream of the pump.

Further, the heat exchanger is provided with a water inlet for inputting water and a water outlet for outputting water, the pump is disposed upstream of the water inlet, and the pressure regulating device is disposed downstream of the water outlet.

Further, the heat exchanger is provided with a water inlet for inputting water and a water outlet for outputting water, and the pump and the pressure regulating device are disposed upstream of the water inlet.

Further, the heat exchanger is provided with a water inlet for inputting water and a water outlet for outputting water, and the pump and the pressure regulating device are disposed downstream of the water outlet.

As is clear from the above technical solutions provided in the embodiments of the present application, a gas inlet structure is disposed on or upstream of the pump which is communicated with the heating unit, by means of which gas inlet structure air is sucked in to be mixed with the water driven by the pump, and thus micro-bubble water is formed and supplied to the users. Under the same flow rate, the water supplied to the users is mixed with air, so that the amount of water used can be effectively saved. In addition, compared with ordinary water, the micro-bubble water has a better cleaning performance and a physical sterilization function, and thus the user experiences would be improved greatly.

### BRIEF DESCRIPTION OF THE DRAWINGS

FIG. 1 is a schematic diagram of the structure of a water heater system provided in the embodiments of the present application;

FIG. 2 is a schematic diagram of the structure of another water heater system provided in the embodiments of the present application;

FIG. 3 is a schematic diagram of the structure of another water heater system provided in the embodiments of the present application;

FIG. 4 is a schematic diagram of the structure of another water heater system provided in the embodiments of the present application;

FIG. 5 is a schematic diagram of the structure of a gas-liquid mixing pump in a water heater system provided in the embodiments of the present application;

FIG. 6 is a schematic diagram of the structure of a Venturi structure provided in the embodiments of the present application;

FIG. 7 is a schematic diagram of the structure of another Venturi structure provided in the embodiments of the present application;

FIG. 8 is a schematic diagram of the structure of a water heater system with a liner provided in the embodiments of the present application;

FIG. 9 is a schematic diagram of the structure of another water heater system with a liner provided in the embodiments of the present application;

FIG. 10 is a schematic diagram of the structure of another water heater system with a liner provided in the embodiments of the present application;

FIG. 11 is a schematic diagram of the structure of another water heater system provided in the embodiments of the present application;

FIG. 12 is a schematic diagram of the structure of a water heater system without a liner provided in the embodiments of the present application;

FIG. 13 is a schematic diagram of the structure of another water heater system without a liner provided in the embodiments of the present application;

FIG. 14 is a schematic diagram of the structure of another water heater system without a liner provided in the embodiments of the present application.

### DETAILED DESCRIPTION OF THE INVENTION

A detailed description of the technical solutions of the present invention is provided hereunder in combination of the figures and the specific embodiments. It should be appreciated that these embodiments are merely used for explaining the present invention rather than for limiting the scope thereof. After reading the present invention, any amendments in an equivalent form made by the persons skilled in the art to the present invention should fall within the scope defined by the attached claims of the present application.

The present invention provides a water heater system that can produce micro-bubble water for use by the users, which is not only water saving and environmental protective, but also can improve the cleaning performance of the water, thus greatly improving the user experiences.

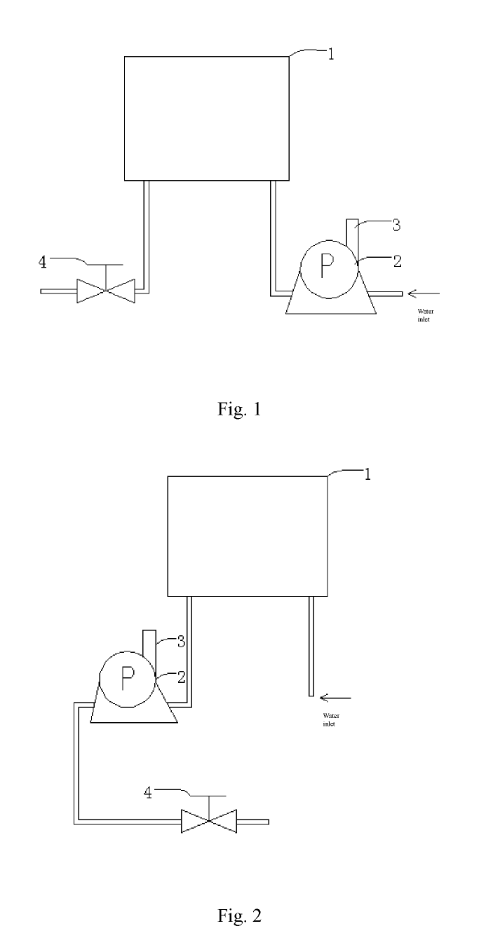

Referring to FIGS. 1 to 4, a water heater system provided in an embodiment of the present application can comprise: a heating unit 1 capable of heating water; a pump 2 communicated with the heating unit 1; a gas inlet structure 3 disposed on or communicated with the pump 2; the pump 2 being capable of mixing the gas and water flowing into it.

In this embodiment, the water heater system is applicable to scenarios of any existing water heaters, including electric water heaters, gas water heaters, solar water heaters and air-source water heaters, etc., and the present application does not make a specific limitation here.

In this embodiment, the heating unit 1 is capable of heating water. The form of the heating unit 1 can vary according to different specific water heater types, and the present application does not make a specific limitation here. For example, when the water heater is an electric water heater, the heating unit 1 can comprise a liner and an electrical heating rod in the liner; and when the water heater is a gas water heater, the heating unit 1 can comprise a combustor and a heat exchanger.

In this embodiment, the pump 2 can be used for providing a driving force for the flow of water communicated with it, wherein the pump 2 can be communicated with the heating unit 1 such that the pump 2 can drive the water to flow through the heating unit 1.

In this embodiment, air can be introduced by means of the gas inlet structure 3 so as to be mixed with the water driven by the pump 2, wherein, the gas inlet structure 3 can be disposed on the pump 2, or be disposed upstream or downstream of the pump 2, and the present application does not make a specific limitation here.

In this embodiment, after air has been introduced into the water by means of the gas inlet structure 3, the pump 2 can mix the air and water that flow to the interior of it, so as to produce micro-bubble water for use by the users. The micro-bubbles refer to bubbles of a size of several or dozens of microns. The surface of the micro-bubbles has a slight negative charge in water, which is capable of absorbing oil, protein and other substances and thereby taking them away from the skin and hair. When the micro-bubble water with micro-bubbles is used for bathing, there are a large number of tiny bubbles every minute that can go deep to the parts, such as hair roots, which are otherwise difficult to be cleaned, and the dirt such as sebum and oil accumulated there can be completely removed.

Moreover, the micro-bubble water also has a unique sterilization function. To be specific, the sterilization process of the micro-bubble water includes two procedures of attracting and killing. The micro-bubble water has static electricity and can absorb the bacteria and viruses in the water; then, as the bubbles shrink and break down, a large number of free radicals are stimulated around the bubbles and ultra-high temperature and pressure are generated by the rupture, and thereby the absorbed bacteria and viruses are killed. The above killing process is a completely physical killing process, which is essentially different from the conventional disinfection and sterilization methods, and thus is more environmentally friendly and healthy compared to conventional chemical sterilizations.

By adoption of the water heater system according to the embodiments of the present application, a gas inlet structure 3 is disposed on or upstream of the pump 2 which is communicated with the heating unit 1, by means of which gas inlet structure 3 air is sucked in to be mixed with the water driven by the pump 2, and thus micro-bubble water is formed and supplied to the users. Under the same flow rate, the water supplied to the users is mixed with air, so that the amount of water used can be effectively saved. In addition, compared with ordinary water, the micro-bubble water has a better cleaning performance and a physical sterilization function, and thus the user experiences would be improved greatly.

In one embodiment, the water heater system can further comprise a pressure regulating device 4 which is disposed downstream of the pump 2.

In this embodiment, the pressure regulating device 4 is used for maintaining a pressure between the pump 2 and the pressure regulating device 4 within a predetermined range. To be specific, the pressure regulating device 4 can be in the form of a kind of pressure regulating valve, such as a self-operated pressure regulating valve, and can be a hydraulic pressure control valve such as an overflow valve, and can also be an electronic expansion valve and a thermal expansion valve of which the pressure can be controlled, or can also be in other forms, and the present application does not make a specific limitation here.

In an specific embodiment, when the pump 2 is started to be operated, the pressure regulating device 4 can maintain the pressure between the pump 2 and the pressure regulating device 4 above 0.2 Mpa.

In this embodiment, when the pump 2 is started to be operated, the pressure regulating device 4 disposed downstream of the pump 2 can maintain a water pressure between the pump 2 and the pressure regulating device 4 within a predetermined pressure range. To be specific, the control principle of the pressure regulating device 4 can vary according to different specific structures of the pressure regulating device 4, and the present application does not make a specific limitation here.

The predetermined pressure range can be above 0.2 Mpa. When the water pressure between the pump 2 and the pressure regulating device 4 is controlled to be above 0.2 Mpa by means of the pressure regulating device 4, the pressure can be beneficial to the generation and maintenance of the micro-bubbles. To be specific, having the pressure to be above 0.2 Mpa on the one hand helps dissolving more air in the water thereby forming the micro-bubble water that has a larger solubility, and on the other hand helps maintaining the state of the micro-bubble water when the micro-bubble water is flowing in the pipes thereby preventing the bubbles in the water from growing gradually. Of course, the predetermined pressure range is not limited to the above examples. Under the inspiration of the technical essence of the present application, a person skilled in the art can also make other alternations, which, however, should all be included in the protection scope of the present application so long as the achieved functions and the obtained effects are identical or similar to that of the present application.

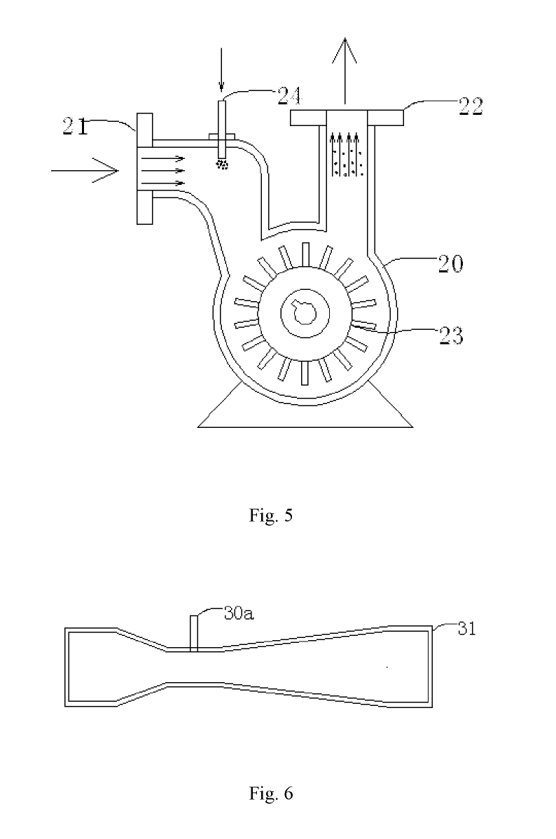

Referring to FIG. 5, in one embodiment, the pump 2 can be a gas-liquid mixing pump, the gas inlet structure 3 is a gas inlet portion 24 provided on the gas-liquid mixing pump, and the gas flows from the gas inlet portion 24 into the gas-liquid mixing pump to be mixed with the water.

In this embodiment, the pump 2 can be in the form of a gas-liquid mixing pump, which is provided with a water inlet port 21 for inputting water and a water outlet port 22 for outputting water, as well as a gas inlet portion 24 for inputting gas. A pump body 20 of the gas-liquid mixing pump is provided in its interior a pump impeller 23 which is capable of high-speed rotation. The high-speed rotating pump impeller 23 can form a negative pressure in the pump body 20 of the gas-liquid mixing pump. The gas inlet portion 24 of the gas-liquid mixing pump can suck in gas by way of the negative pressure. By means of the high-speed rotating pump impeller 23 inside the gas-liquid mixing pump, a liquid flowed in from the water inlet port 21 and the gas sucked in from the gas inlet portion 24 can be mixed and stirred and thereafter be discharged from the water outlet port 22. The gas-liquid mixing pump has a high pressure therein. In general, the gas and liquid can be highly dissolved as being mixed in the pump under pressure.

Referring to FIG. 4, in one embodiment, the pump 2 is a gas-liquid mixing pump, and the gas inlet structure 3 is disposed on a water supply pipe which is upstream of the gas-liquid mixing pump.

In this embodiment, the pump 2 can be in the form of a gas-liquid mixing pump, which is provided with a water inlet port 21 for inputting water and a water outlet port 22 for outputting water. A pump body 20 of the gas-liquid mixing pump is provided in its interior a pump impeller 23 which is capable of high-speed rotation. The high-speed rotating pump impeller 23 can form a negative pressure in the pump body 20 of the gas-liquid mixing pump.

In this embodiment, the gas inlet structure 3 can be disposed on a water supply pipe which is upstream of the gas-liquid mixing pump, for sucking gas into the water in the water supply pipe. The gas sucked in by means of the gas inlet structure 3 and the water in the water supply pipe are preliminarily mixed with each other, and fed into the gas-liquid mixing pump by means of the suction effect of the gas-liquid mixing pump, and then sufficiently mixed under the effect of rotating stirring of the high-speed rotating pump impeller 23.

In this embodiment, the gas inlet structure 3 can be a structure capable of gas suction, or can be a structure capable of gas releasing. For example, the gas inlet structure 3 can be a Venturi structure, or can be a tank that can supply gas. Of course, the specific form of the gas inlet structure 3 is not specifically limited here in the present application. Under the inspiration of the technical essence of the present application, a person skilled in the art can also make other alternations, which, however, should all be included in the protection scope of the present application so long as the achieved functions and the obtained effects are identical or similar to that of the present application.

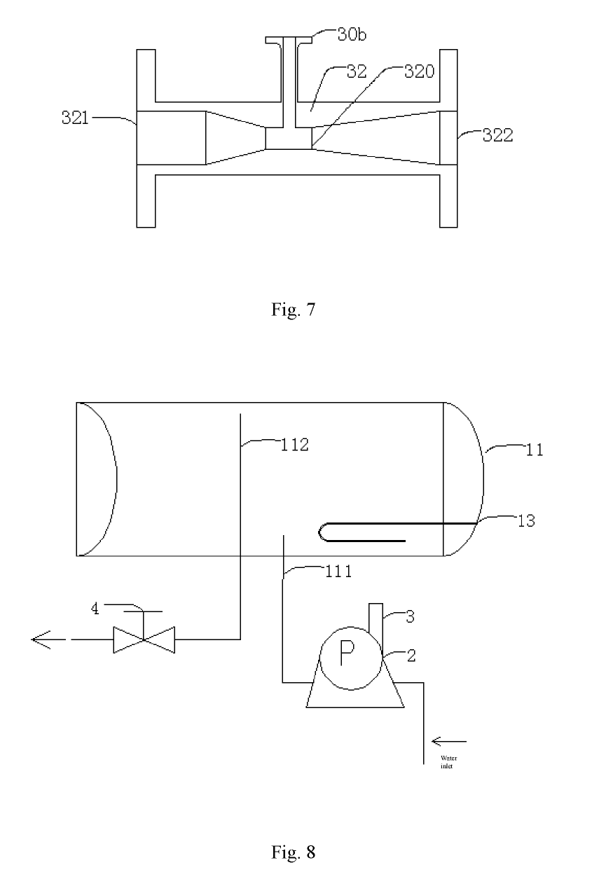

Referring to FIGS. 6 and 7, in a specific embodiment, the gas inlet structure 3 is provided with a Venturi structure.

In this embodiment, the gas inlet structure 3 can be in the form of a Venturi structure. To be specific, when the gas inlet structure 3 is in the form of a Venturi structure, the Venturi structure can be a necking-down tube formed on the water supply pipe or a Venturi structure connected on the water supply pipe.

When the Venturi structure is a necking-down tube 31 formed on the water supply pipe, a gas suction port 30a is provided at the necking-down position of the necking-down tube 31.

When the Venturi structure is an independent structure connected on the water supply pipe, it includes a body 32, as well as a water inlet 321 and a water outlet 322 provided at two ends of the body 32. A cavity 320 is formed within the body 32, the cavity having a cross-sectional area which changes from large to small and then from small to large. A gas suction port 30b in communication with the cavity 320 is provided at the position of the body 32 where the cross-sectional area is changed. The water inlet 321 and the water outlet 322 are respectively sealingly connected with the water supply pipe. The sealing connection manner can be a flange connection.

When the pump 2 is started and water flows through the necking-down tube 31 or the cavity 320, the cross-sectional area for passage of the water flow becomes smaller, the flow velocity becomes larger, and the corresponding pressure becomes smaller. When the pressure is smaller than the external atmospheric pressure, a negative pressure cavity is formed within the necking-down tube 31 or the cavity 320, enabling the outside air to be sucked in through the gas suction port and be preliminarily mixed with the water flowing through the interior of the Venturi structure.

In a specific embodiment, the gas inlet structure 3 can be a tank that can supply gas, and the tank is used for supplying gas to the water flowing through it.

In this embodiment, the gas inlet structure 3 can be a tank that can supply gas. To be specific, when the gas inlet structure 3 is a tank that can supply gas, the tank can be provided with an outlet for gas. The outlet can be communicated with the water supply pipe. A valve can be provided at the position of the outlet of the tank for controlling the outlet to be communicated or not to be communicated with the water supply pipe. The tank contains therein a liquid or a gas-liquid mixture which has been pre-compressed. When the valve is opened, the liquid in the tank can be vaporized into gas and enters the water supply pipe to be mixed with the water in the pipe.

In one embodiment, the pump 2 comprises a first pump and a second pump which are connected with each other in series or in parallel.

In this embodiment, the pump 2 can comprise a first pump and a second pump. Of course, the number of the pump 2 can be two or more, and the present application does not make a specific limitation here.

In this embodiment, the first pump and the second pump can be connected in series or in parallel.

When the pressure demanded by the water heater system is large, a connection of the first pump and the second pump in series can be selected. The pressure that can be provided when the first pump and the second pump are connected in series is considerably improved compared with the pressure that can be provided by a single pump, and thus can satisfy the demand for pressure of the water heater system.

When the flow rate demanded by the water heater system is large, a connection of the first pump and the second pump in parallel can be selected. The flow rate that can be provided when the first pump and the second pump are connected in parallel is considerably improved compared with the flow rate that can be provided by a single pump, and thus can satisfy the demand for flow rate of the water heater system.

Furthermore, in general, the water heater system needs to be arranged within a housing. When the space of the housing is constant, the two small pumps can flexibly make use of the fragmented space in the housing, which can reduce the overall space occupied by the water heater system to a certain extent.

Referring to FIG. 1, in a specific embodiment, the pump 2 is disposed upstream of the heating unit 1, and the pressure regulating device 4 is disposed downstream of the heating unit 1.

In this embodiment, the pump 2 can be disposed upstream of the heating unit 1. When the pump 2 is disposed upstream of the heating unit 1, the water that has been heated in the heating unit 1 will not flow through the pump 2. In contrast, the water that flows through the pump 2 is normal temperature water provided from the water supply pipe. Thus, for the pump 2, there is no requirement for high temperature resistance. In addition, since the water that flows through the pump 2 is normal temperature water, the calcium and magnesium ions in the water are not easy to be separated out, and therefore it is not easy to scale inside the pump.

In this embodiment, the pressure regulating device 4 can be disposed downstream of the heating unit 1, wherein, the downstream of the heating unit 1 is generally close to a water-using terminal of the users. When the pressure regulating device 4 is disposed downstream of the heating unit 1, the water outlet pressure at the user terminal can be maintained close to a predetermined pressure of the pressure regulating device 4, thereby ensuring the micro-bubble water of an ideal effect to be discharged from the user terminal.

Referring to FIG. 2, in a specific embodiment, the pump 2 and the pressure regulating device 4 are disposed downstream of the heating unit 1.

In this embodiment, the pump 2 can be disposed downstream of the heating unit 1. When the pump 2 is disposed downstream of the heating unit 1, the water flowed out from the heating unit 1 is directly mixed with the gas under the effect of the pump 2 to form micro-bubble water to be supplied to the water-using terminal of the users. In contrast, when the micro-bubble water flowed out from the pump 2 does not flow through the heating unit 1, on the one hand, the users are allowed to get the micro-bubble water in a short time, and on the other hand, it is possible to avoid the micro-bubble water from being diluted by the water stored in the heating unit 1 or being heated by the heating unit 1 thereby producing temperature fluctuation interference caused by temperature rise after entering the heating unit 1.

In this embodiment, the pressure regulating device 4 can be disposed downstream of the heating unit 1, wherein, the downstream of the heating unit 1 is generally close to the water-using terminal of the users. When the pressure regulating device 4 is disposed downstream of the heating unit 1, the water outlet pressure at the user terminal can be maintained close to a predetermined pressure of the pressure regulating device 4, thereby ensuring the micro-bubble water of an ideal effect to be discharged from the user terminal.

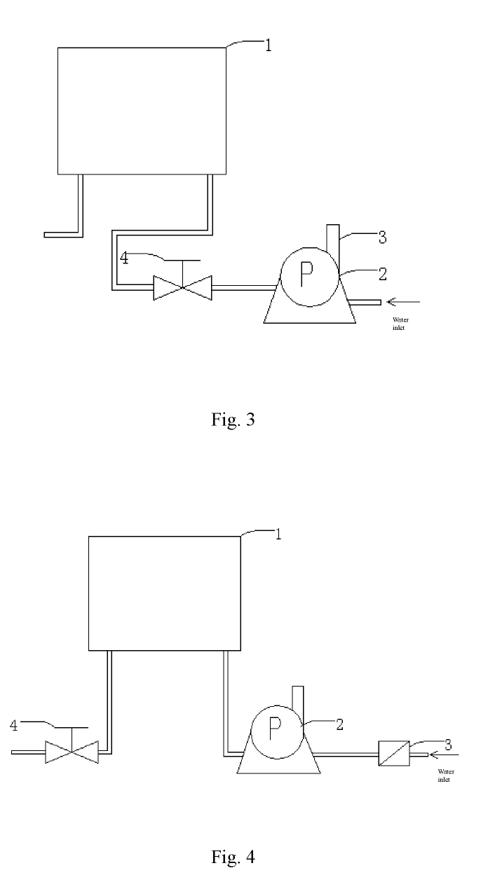

Referring to FIG. 3, in a specific embodiment, the pump 2 and the pressure regulating device 4 are disposed upstream of the heating unit 1.

In this embodiment, the pump 2 can be disposed upstream of the heating unit 1. When the pump 2 is disposed upstream of the heating unit 1, the water that has been heated in the heating unit 1 will not flow through the pump 2. In contrast, the water that flows through the pump 2 is normal temperature water from an water inlet end. Thus, for the pump 2, there is no requirement for high temperature resistance. In addition, since the water that flows through the pump 2 is normal temperature water, the calcium and magnesium ions in the water are not easy to be separated out, and therefore it is not easy to scale inside the pump.

In this embodiment, the pressure regulating device 4 can be disposed upstream of the heating unit 1, When the pressure regulating device 4 is disposed upstream of the heating unit 1, the water that has been heated in the heating unit 1 will not flow through the pressure regulating device 4. In contrast, the water flowing through the pump 2 is unheated normal temperature water. Therefore, for the pressure regulating device 4, there is no requirement for high temperature resistance. Besides, since the water that flows through the pressure regulating device 4 is normal temperature water, the calcium and magnesium ions in the water are not easy to be separated out, and therefore it is not easy to scale inside the pressure regulating device.

Referring to FIGS. 8 to 10, in one embodiment, the heating unit 1 can comprise: a liner 11 capable of containing water, and a heating member 13 for heating the water in the liner 11.

In this embodiment, the water heater system can be applied in a water heater with a liner 11. To be specific, the heating unit 1 can comprise: a liner 11 and a heating member 13, wherein the liner 11 can be used to contain water. To be specific, the liner 11 can be a hollow cylindrical housing as a whole, and can certainly have other shapes. The present application does not make a specific limitation to this here. The liner 11 can be disposed in a horizontal manner, and can also be disposed in a vertical manner. The present application does not make a limitation to this here.

The type and the setting manner of the heating member 13 can vary according to different water heater types. For example, when the water heater is an electric water heater, the heating member 13 can be an electrical heating rod. The electrical heating rod can have one end thereof fixed to a wall of the liner 11, while the other end thereof extending into the liner 11 to heat the water in the liner 11. When the water heater is a heat-pump water heater, the heating member 13 can be a heat exchanger provided on the liner 11. For example, the heat exchanger can be wrapped on an outer wall of the liner 11, and a high-temperature high-pressure refrigerant is flowing in the heat exchanger. When the high-temperature high-pressure refrigerant flows through the heat exchanger, it can transfer heat to the water in the liner 11.

In one embodiment, the water heater system with the liner 11 can further comprise a pressure regulating device 4 which is disposed downstream of the pump 2.

In this embodiment, the pressure regulating device 4 can be disposed downstream of the pump 2 in the water heater with the liner 11, such as a liner equipped electric water heater, heat-pump water heater etc.

In this embodiment, the pressure regulating device 4 is used for maintaining a pressure between the pump 2 and the pressure regulating device 4 within a predetermined range. To be specific, the pressure regulating device 4 can be in the form of a kind of pressure regulating valve, such as a self-operated pressure regulating valve, and can be a hydraulic pressure control valve such as an overflow valve, and can also be an electronic expansion valve and a thermal expansion valve of which the pressured can be controlled, or can also be in other forms. The present application does not make a specific limitation to this here.

In this embodiment, when the pump 2 is started to be operated, the pressure regulating device 4 disposed downstream of the pump 2 can maintain a water pressure between the pump 2 and the pressure regulating device 4 within a predetermined pressure range. To be specific, the control principle of the pressure regulating device 4 can vary according to different specific structures of the pressure regulating device 4, and the present application does not make a specific limitation here.

Referring to FIG. 8, in a specific embodiment, the liner 11 is provided with a water inlet pipe 111 for inputting water and a water outlet pipe 112 for outputting water, the pump 2 is disposed upstream of the water inlet pipe 11, and the pressure regulating device 4 is disposed downstream of the water outlet pipe 112.

In this embodiment, the liner 11 is provided with the water inlet pipe 111 for inputting water and the water outlet pipe 112 for outputting water. The normal temperature water provided from the water supply pipe can enter the liner 11 via the water inlet pipe 111 to be heated, and the heated water flows out from the water outlet pipe 112.

In this embodiment, the pump 2 can be disposed upstream of the water inlet pipe 111 of the liner 11. When the pump 2 is disposed upstream of the water inlet pipe 111 of the liner 11, the water that has been heated in the heating unit 11 will not pass through the pump 2. In contrast, the water that flows through the pump 2 is normal temperature water provided through the water supply pipe. Thus, for the pump 2, there is no requirement for high temperature resistance. In addition, since the water that flows through the pump 2 is normal temperature water, the calcium and magnesium ions in the water are not easy to be separated out, and therefore it is not easy to scale inside the pump.

In this embodiment, the pressure regulating device 4 can be disposed downstream of the water outlet pipe 112 of the liner 11, wherein, the downstream of the water outlet pipe 112 of the liner 11 is generally close to the water-using terminal of the users. When the pressure regulating device 4 is disposed downstream of the water outlet pipe 112 of the liner 11, the water outlet pressure at the user terminal can be maintained close to a predetermined pressure of the pressure regulating device 4, thereby ensuring the micro-bubble water of an ideal effect to be discharged from the user terminal.

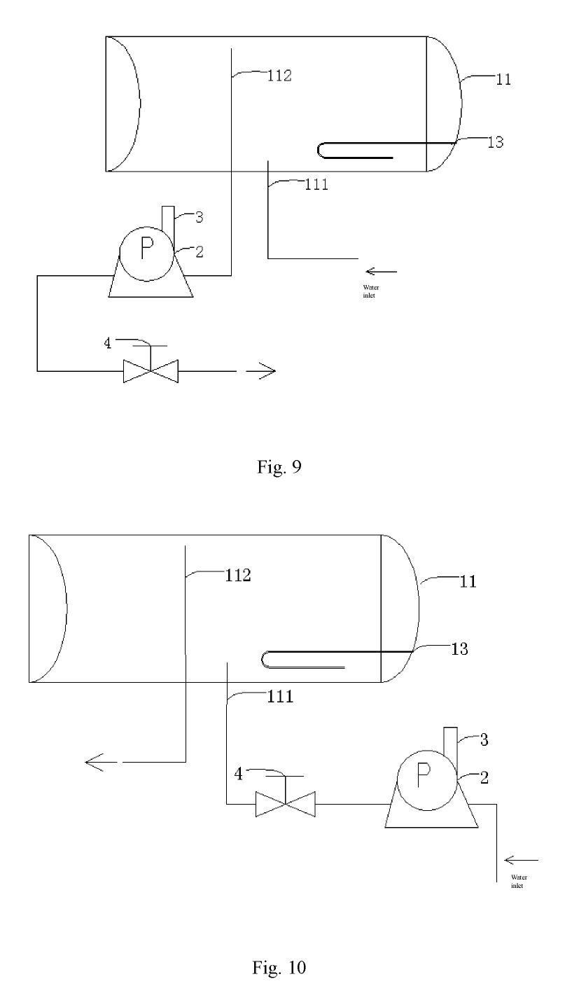

Referring to FIG. 9, in a specific embodiment, the liner 11 is provided with a water inlet pipe 111 for inputting water and a water outlet pipe 112 for outputting water, and the pump 2 and the pressure regulating device 4 are disposed downstream of the water outlet pipe 112.

In this embodiment, the liner 11 is provided with the water inlet pipe 111 for inputting water and the water outlet pipe 112 for outputting water. The normal temperature water provided from the water supply pipe can enter the liner 11 via the water inlet pipe 111 to be heated, and the heated water flows out from the water outlet pipe 112.

In this embodiment, the pump 2 can be disposed downstream of the water inlet pipe 112 of the liner 11. When the pump 2 is disposed downstream of the water outlet pipe 112 of the liner 11, the water flowed out from the liner 11 is directly mixed with the gas under the effect of the pump 2 to form the micro-bubble water to be supplied to the water-using terminal of the users. In contrast, when the micro-bubble water flowed out from the pump 2 does not pass through the liner 11, on the one hand, the users are allowed to get the micro-bubble water in a short time, and on the other hand, it is possible to avoid the micro-bubble water from being diluted by the water stored in the liner 11 or being heated by the heating member 13 thereby producing temperature fluctuation interference caused by temperature rise after entering the liner 11.

In this embodiment, the pressure regulating device 4 can be disposed downstream of the water outlet pipe 112 of the liner 11, wherein, the downstream of the water outlet pipe 112 of the liner 11 is generally close to the water-using terminal of the users. When the pressure regulating device 4 is disposed downstream of the water outlet pipe 112 of the liner 11, the water outlet pressure at the user terminal can be maintained close to a predetermined pressure of the pressure regulating device 4, thereby ensuring the micro-bubble water of an ideal effect to be discharged from the user terminal.

Referring to FIG. 10, in a specific embodiment, the liner 11 is provided with a water inlet pipe 111 for inputting water and a water outlet pipe 112 for outputting water, and the pump 2 and the pressure regulating device 4 are disposed upstream of the water inlet pipe 111.

In this embodiment, the liner 11 is provided with the water inlet pipe 111 for inputting water and the water outlet pipe 112 for outputting water. The normal temperature water provided from the water supply pipe can enter the liner 11 via the water inlet pipe 111 to be heated, and the heated water flows out from the water outlet pipe 112.

In this embodiment, the pump 2 can be disposed upstream of the water inlet pipe 111 of the liner 11. When the pump 2 is disposed upstream of the water inlet pipe 111 of the liner 11, the water that has been heated in the heating unit 11 will not flow through the pump 2. In contrast, the water that flows through the pump 2 is normal temperature water from an water inlet end. Thus, for the pump 2, there is no requirement for high temperature resistance. Besides, since the water that flows through the pump 2 is normal temperature water, the calcium and magnesium ions in the water are not easy to be separated out, and therefore it is not easy to scale inside the pump.

In this embodiment, the pressure regulating device 4 can be disposed upstream of the water inlet pipe 111 of the liner 11. When the pressure regulating device 4 is disposed upstream of the water inlet pipe 111 of the liner 11, the water that has been heated in the liner 11 will not flow through the pressure regulating device 4. In contrast, the water flowing through the pump 2 is unheated normal temperature water. Therefore, for the pressure regulating device 4, there is no requirement for high temperature resistance. Besides, since the water that flows through the pressure regulating device 4 is normal temperature water, the calcium and magnesium ions in the water are not easy to be separated out, and therefore it is not easy to scale inside the pressure regulating device.

In one embodiment, the liner 11 is a pressure-bearing liner 11 having a liner pressure ranged from 0.1 MPa to 0.8 MPa.

In this embodiment, the liner 11 is communicated with the pump 2. To be specific, after the pump 2 is activated, the liner 11 is communicated with the inlet or outlet of the pump 2. The pump 2 provides a gas-liquid mixture with pressure for the liner 11 from the inlet, or the heated water in the liner 11 is pumped into the pump body by means of the pump 2. In contrast, the liner 11 is influenced by the pump 2 and also needs to bear a certain pressure. In addition, due to the change of the water temperature in the liner 11, the effect of expansion caused by heat and contraction caused by cold also requires the liner 11 to have a certain pressure bearing capacity. In conclusion, the liner 11 in communication with the pump 2 needs to bear a predetermined pressure when used. To be specific, the pressure can be ranged from 0.1 Mpa to 0.8 Mpa. For example, when the pump 2 is located downstream of the liner 11, the range of the liner pressure of the liner 11 can be relatively smaller; and when the pump 2 is located upstream of the liner 11, as the micro-bubble water outputted from the pump 2 is flowing through the liner 11, the range of the liner pressure can be relatively larger so as to maintain the pressure required by the micro-bubble water.

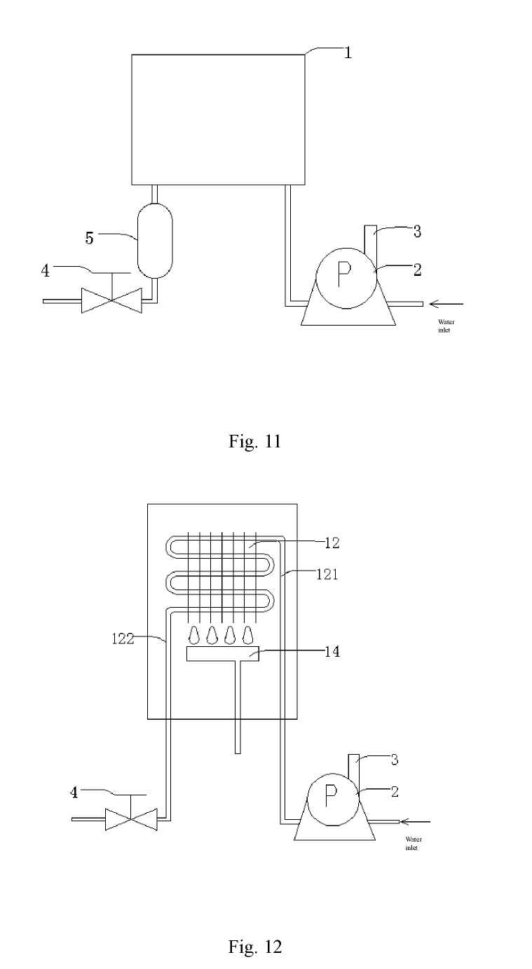

Referring to FIG. 11, in one embodiment, the water heater system can further comprise a tank 5 capable of being communicated with the pump 2 for further mixing the gas and water, the tank 5 is disposed downstream of the pump 2, and the pressure regulating device 4 is disposed downstream of the tank 5.

In this embodiment, the water heater system can also comprise the tank 5 communicated with the heating unit 1 and the pump 2. The tank 5 can be disposed downstream of the pump 2 for further mixing the gas-liquid mixture flowed out from the pump 2.

The tank 5 can be a tank that can further mix the gas and water. To be specific, the tank 5 can comprise opposite inlet and outlet, and can store therein a gas having a predetermined pressure. A valve can be disposed at the position of the outlet. When the gas-liquid mixture flowed out from the pump 2 enters the tank 5 through the inlet of the tank 5, it can be further mixed with the gas in the tank 5, and thereby the gas-liquid mixing degree is improved.

In this embodiment, the pressure regulating device 4 is disposed downstream of the tank 5, Overall, the pressure regulating device 4 can be located at the most downstream position of the water heater system so as to be close to the water-using terminal of the users, such that the water outlet pressure at the water-using terminal can be maintained close to a predetermined pressure of the pressure regulating device 4, thereby ensuring the micro-bubble water of an ideal effect to be discharged from the user terminal.

Referring to FIGS. 12 to 14, in one embodiment, the heating unit 1 can comprise: a heat exchanger 12 through which water can flow, and a heating means 14 for heating the water that flows through the heat exchanger 12.

In this embodiment, the water heater system is applicable in gas water heaters, solar water heaters, instant-heating heat-pump water heaters or instant-heating electric water heaters which do not have a liner. To be specific, the heating unit 1 can comprise: a heat exchanger 12 and a heating means 14, wherein the water to be heated is flowing in the heat exchanger 12 of which one end is in communication with a water inlet end and the other end is in communication with a water outlet end. The heating means 14 can be used to heat the water flow in the heat exchanger 12. The specific form of the heating means 14 can vary according to different actual application scenarios. For example, when the water heater system is a gas water heater, the heating means 14 can be a combustor.

In one embodiment, the water heater system provided with the heat exchanger 12 and the heating means 14 can further comprise a pressure regulating device 4 which is disposed downstream of the pump 2.

In this embodiment, the water heater system provided with the heat exchanger 12 and the heating means 14 can be provided with the pressure regulating device 4 which is disposed downstream of the pump 2.

In this embodiment, the pressure regulating device 4 is used for maintaining a pressure between the pump 2 and the pressure regulating device 4 within a predetermined range. To be specific, the pressure regulating device 4 can be in the form of a kind of pressure regulating valve, such as a self-operated pressure regulating valve, and can be a hydraulic pressure control valve such as an overflow valve, and can also be an electronic expansion valve and a thermal expansion valve of which the pressured can be controlled, or can also be in other forms, and the present application does not make a specific limitation here.

In this embodiment, when the pump 2 is started to be operated, the pressure regulating device 4 disposed downstream of the pump can maintain a water pressure between the pump 2 and the pressure regulating device 4 within a predetermined pressure range. To be specific, the control principle of the pressure regulating device 4 can vary according to different specific structures of the pressure regulating device 4, and the present application does not make a specific limitation here.

Referring to FIG. 12, in a specific embodiment, the heat exchanger 12 is provided with a water inlet 121 for inputting water and a water outlet 122 for outputting water, the pump 2 is disposed upstream of the water inlet 121, and the pressure regulating device 4 is disposed downstream of the water outlet 122.

In this embodiment, the heat exchanger 12 is provided with the water inlet 121 for inputting water and the water outlet 122 for outputting water. The normal temperature water provided from the water supply pipe enters the heat exchanger 12 via the water inlet 121 to be heated by the heating means 14, and the heated water flows out from the water outlet 122.

In this embodiment, the pump 2 can be disposed upstream of the water inlet pipe 121 of the heat exchanger 12. When the pump 2 is disposed upstream of the water inlet 121 of the heat exchanger 12, the water that has been heated in the heating unit 12 will not flow through the pump 2. In contrast, the water that flows through the pump 2 is normal temperature water provided through the water supply pipe. Thus, for the pump 2, there is no requirement for high temperature resistance. Besides, since the water that flows through the pump 2 is normal temperature water, the calcium and magnesium ions in the water are not easy to be separated out, and therefore it is not easy to scale inside the pump.

In this embodiment, the pressure regulating device 4 can be disposed downstream of the water outlet 122 of the heat exchanger 12, wherein, the downstream of the water outlet 122 of the heat exchanger 12 is generally close to the water-using terminal of the users. When the pressure regulating device 4 is disposed downstream of the water outlet 122 of the heat exchanger 12, the water outlet pressure at the user terminal can be maintained close to a predetermined pressure of the pressure regulating device 4, thereby ensuring the micro-bubble water of an ideal effect to be discharged from the user terminal.

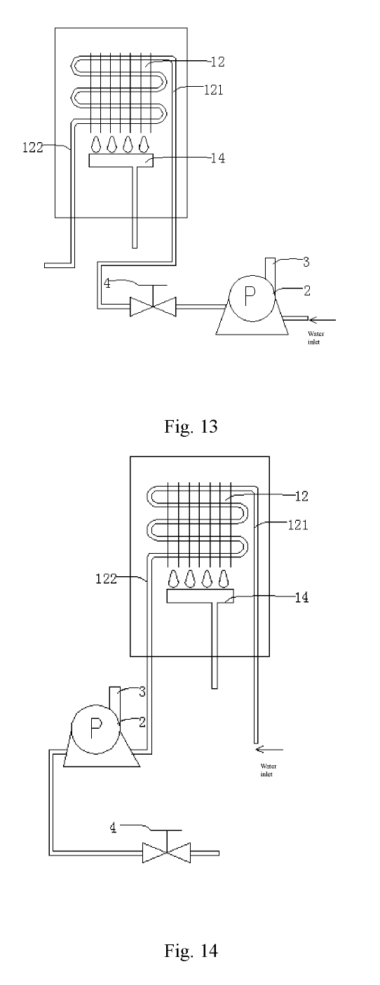

Referring to FIG. 13, in a specific embodiment, the heat exchanger 12 is provided with a water inlet 121 for inputting water and a water outlet 122 for outputting water, and the pump 2 and the pressure regulating device 4 are disposed upstream of the water inlet 121.

In this embodiment, the heat exchanger 12 is provided with the water inlet 121 for inputting water and the water outlet 122 for outputting water. The normal temperature water provided from the water supply pipe can enter the heat exchanger 12 via the water inlet 121 to be heated by the heating means 14, and the heated water flows out from the water outlet 122.

In this embodiment, the pump 2 can be disposed upstream of the water inlet 121 of the heat exchanger 12. When the pump 2 is disposed upstream of the water inlet 121 of the heat exchanger 12, the water that has been heated in the heat exchanger 12 will not flow through the pump 2. In contrast, the water flowing through the pump 2 is normal temperature water from a water inlet end. Therefore, for the pump 2, there is no requirement for high temperature resistance. Besides, since the water that flows through the pump 2 is normal temperature water, the calcium and magnesium ions in the water are not easy to be separated out, and therefore it is not easy to scale inside the pump.

In this embodiment, the pressure regulating device 4 can be disposed upstream of the water inlet 121 of the heat exchanger 12. When the pressure regulating device 4 is disposed upstream of the water inlet 121 of the heat exchanger 12, the water that has been heated in the heat exchanger 12 will not flow through the pressure regulating device 4. In contrast, the water flowing through the pump 2 is unheated normal temperature water. Therefore, for the pressure regulating device 4, there is no requirement for high temperature resistance. Besides, since the water that flows through the pressure regulating device 4 is normal temperature water, the calcium and magnesium ions in the water are not easy to be separated out, and therefore it is not easy to scale inside the pressure regulating device.

Referring to FIG. 14, in a specific embodiment, the heat exchanger 12 is provided with a water inlet 121 for inputting water and a water outlet 122 for outputting water, and the pump 2 and the pressure regulating device 4 are disposed downstream of the water outlet 122.

In this embodiment, the heat exchanger 12 is provided with the water inlet 121 for inputting water and the water outlet 122 for outputting water. The normal temperature water provided from the water supply pipe can enter the heat exchanger 12 via the water inlet 121 to be heated by the heating means 14, and the heated water flows out from the water outlet 122.

In this embodiment, the pump 2 can be disposed downstream of the water outlet 122 of the heat exchanger 12. When the pump 2 is disposed downstream of the water outlet 122 of the heat exchanger 12, the water flows out from the heat exchanger 12 is directly mixed with the gas under the effect of the pump 2 to form the micro-bubble water to be supplied to the water-using terminal of the users. In contrast, when the micro-bubble water flowed out from the pump 2 does not flow through the heat exchanger 12, on the one hand, the users are allowed to get the micro-bubble water in a short time, and on the other hand, it is possible to avoid the micro-bubble water from being diluted by accumulated water in the pipe or being heated by the heating means 14 thereby producing temperature fluctuation interference caused by temperature rise after entering the heat exchanger 12.

In this embodiment, the pressure regulating device 4 can be disposed downstream of the water outlet 122 of the heat exchanger 12, wherein, the downstream of the water outlet 122 of the heat exchanger 12 is generally close to the water-using terminal of the users. When the pressure regulating device 4 is disposed downstream of the water outlet 122 of the heat exchanger 12, the water outlet pressure at the user terminal can be maintained close to a predetermined pressure of the pressure regulating device 4, thereby ensuring the micro-bubble water of an ideal effect to be discharged from the user terminal.

Each of the above embodiments of the present invention is described in a progressive manner. The same and similar parts among the embodiments can be cross-referenced. The content emphasized in each embodiment is the difference from the other embodiments.

The above are only a few embodiments of the present invention. Although the embodiments disclosed in the present invention are described above, they are adopted only for the convenience of understanding the present invention, and are not used for limiting the present invention. Any skilled persons in the technical field to which the present invention belongs can, without departing from the spirit and scope disclosed in the present invention, make any modification or change to the form and details of the embodiments, but the scope of patent protection of the present invention shall still be subject to the scope defined in the attached patent claims.

What is claimed is:

1. A water heater system, wherein the water heater system comprises:
a heating unit capable of heating water;
a pump communicated with the heating unit;
a gas inlet structure disposed on or communicated with the pump;
the pump being capable of mixing a gas and water flowing into it.

2. The water heater system according to claim 1, wherein the water heating system further comprises a pressure regulating device which is disposed downstream of the pump.

3. The water heater system according to claim 1, wherein the pump is a gas-liquid mixing pump, the gas inlet structure is a gas inlet portion disposed on the gas-liquid mixing pump, and the gas flows from the gas inlet portion into the gas-liquid mixing pump to be mixed with water.

4. The water heater system according to claim 1, wherein the pump is a gas-liquid mixing pump, and the gas inlet structure is disposed on a water supply pipe which is upstream of the gas-liquid mixing pump.

5. The water heater system according to claim 4, wherein the gas inlet structure is provided with a Venturi structure.

6. The water heater system according to claim 2, wherein the pump is disposed upstream of the heating unit, and the pressure regulating device is disposed downstream of the heating unit.

7. The water heater system according to claim 2, wherein the pump and the pressure regulating device are disposed downstream of the heating unit.

8. The water heater system according to claim 2, wherein the pump and the pressure regulating device are disposed upstream of the heating unit.

9. The water heater system according to claim 1, wherein the heating unit comprises: a liner capable of containing water, and a heating member for heating the water in the liner.

10. The water heater system according to claim 9, wherein the water heating system further comprises a pressure regulating device which is disposed downstream of the pump.

11. The water heater system according to claim 10, wherein the liner is provided with a water inlet pipe for inputting water and a water outlet pipe for outputting water,
the pump being disposed upstream of the water inlet pipe, and the pressure regulating device being disposed downstream of the water outlet pipe.

12. The water heater system according to claim 10, wherein the liner is provided with a water inlet pipe for inputting water and a water outlet pipe for outputting water,
the pump and the pressure regulating device being disposed downstream of the water outlet pipe.

13. The water heater system according to claim 10, wherein the liner is provided with a water inlet pipe for inputting water and a water outlet pipe for outputting water,
the pump and the pressure regulating device being disposed upstream of the water inlet pipe.

14. The water heater according to claim 10, wherein,
the liner is a pressure-bearing liner having a liner pressure ranged from 0.1 MPa to 0.8 MPa.

15. The water heater system according to claim 2, wherein the water heater system further comprises a tank capable of being communicated with the pump for further mixing the gas and the water, the tank is disposed downstream of the pump, and the pressure regulating device is disposed downstream of the tank.

16. The water heater system according to claim 4, wherein the gas inlet structure is a tank that can supply gas, and the tank is used for supplying gas to the water flowing through it.

17. The water heater system according to claim 1, wherein, the pump comprises a first pump and a second pump which are connected with each other in series or in parallel.

18. The water heater system according to claim 2, wherein, when the pump is started to be operated, the pressure regulating device can maintain a pressure between the pump and the pressure regulating device above 0.2 Mpa.

19. The water heater system according to claim 1, wherein the heating unit comprises: a heat exchanger through which water can flow, and a heating means for heating the water that flows through the heat exchanger.

20. The water heater system according to claim 19, wherein the water heating system further comprises a pressure regulating device which is disposed downstream of the pump.
